(19) United States
(12) Patent Application Publication
(10) Pub. No.: US 2013/0145454 A1
(43) Pub. Date: Jun. 6, 2013

(54) PORTABLE INFORMATION TERMINAL, ITS CONTROL METHOD AND PROGRAM

(71) Applicant: Hitachi Consumer Electronics Co., Ltd., Tokyo (JP)

(72) Inventor: KAZUHIKO YOSHIZAWA, Yokohama (JP)

(73) Assignee: Hitachi Consumer Electronics Co., Ltd., Tokyo (JP)

(21) Appl. No.: 13/683,274

(22) Filed: Nov. 21, 2012

(30) Foreign Application Priority Data
Dec. 5, 2011 (JP) 2011-265384

(51) Int. Cl. G06F 21/00

(52) U.S. Cl. CPC G06F 21/00
USPC 726/16

(57) ABSTRACT

Disclosed are a portable information terminal for materializing limitation of its use more effectively and method and program for controlling the terminal The portable information terminal comprises a mail address storing unit for storing mail addresses, a mail reception unit for receiving mails, a certification information generation unit for generating certification information and a terminal lock controlling unit for limiting a predetermined function or operation, wherein when a mail address of an originator of transmission of a mail received by the mail reception unit coincides with an address stored in the mail address storing unit, the predetermined function or operation is limited by certification information the certification information generating unit generates.

### INCORPORATION BY REFERENCE

The present application claims priority from Japanese application JP2011-265384 filed on Dec. 5, 2011, the content of which is hereby incorporated by reference into this application.

### BACKGROUND OF THE INVENTION

The present invention relates to a portable information terminal, its control method and program.

In recent years, with widespread use of a portable information terminal such as a pocket telephone and a smartphone advanced. portable information terminals have been possessed by many persons. Also, as the hardware has been advancing, the portable information terminal has been so constructed as to be able to hold many pieces of personal data and to have, for example, the function of money transactions based on the electronic money function. For these reasons, in the event of losing a portable information terminal, leakage of personal data and money damage due to unauthorized use by a third person have been more feared nowadays than before.

In order to prevent such a damage as caused by the unauthorized use by the third party, a portable information terminal has been proposed in which when a possessor has lost the portable information terminal, the use of the terminal is limited through remote operation

For example, JP-A-2004-356685 describes “In the event that a person mislays or loses a pocket telephone (step S1), the person communicates with a service center of contract communication enterpriser by using another phone to ask for switching the pocket telephone to a limit mode (step S3) or deals with the event by operating a possessed personal computer (PC) through internet (step S6) The service center compares and collates a communicated password with a password registered in advance (step S5) and when the coincidence is obtained, an electronic mail is transmitted to the pocket telephone of the communicated telephone number so that the pocket telephone may be switched automatically and forcibly from the ordinary mode to a limit mode (step S9).”

Further, JP-A-2011-77962 has for its object “Offering a radio terminal device having the function based on mail which is useful in such an event that for example, a user has mislaid a pocket telephone”, and describes such a countermeasure as “In a radio terminal device 3 having the mail communication function by radio, a mail communication unit communicates mails by radio, a setting storing unit memorizes a condition concerning a received mail inclusive of a mail address of an originator of transmission in corresponding relation to the operation and a judging unit makes a decision as to whether the mail received by the mail communication unit meets the condition memorized in the setting storing unit and, when the judging unit determines that the condition memorized in the setting storing unit is met, an operation executing unit carries out an operation corresponding to the condition in the setting storing unit”.

### SUMMARY OF THE INVENTION

Limitations on the use of the portable information terminal are considered to be unlocked through the use of a PIN (Personal Identification Number). For example, however, when the possessor registers a simple PIN such as “1111”, there is a possibility that the PIN can be deciphered relatively easily by a third person who has found and picked up the portable information terminal. Especially, when, in such an event, the use of the portable information terminal is simply limited upon reception of the predetermined mail as described in JP-A-2004-356685 or JP-A-2011-77962, the limitation will possibly be unlocked with ease by the third person.

In the light of the problems as above, an object of the present invention is to provide a portable information terminal, its control method and program which can materialize more effectively limitations to be imposed on the use of portable information terminal.

The terminal, its control method and program will be constructed and prepared as recited in each of the appended claims.

According to an embodiment of the invention, a portable information terminal comprises a mail address storing unit for storing mail addresses, a mail receiving unit for receiving mails, a certification information generating unit for generating pieces of certification information and a terminal lock control unit adapted to control locking of the terminal so as to limit a predetermined function or operation, wherein when a mail address stored in the mail address storing unit coincides with a mail address of an originator of transmission of a mail received by the mail receiving unit, the predetermined function or operation is limited by certification information generated by the certification information generating unit.

According to the present invention, a portable information terminal, its control method and program can be provided which can materialize more efficiently the limitation to be imposed on the use of portable information terminal.

### BRIEF DESCRIPTION OF THE DRAWINGS

FIG. 1 is a block diagram of a portable information terminal according to a first embodiment of the invention.

FIG. 2 is a diagram rating a configuration of a communication system in the first embodiment.

FIG. 3 is a flowchart showing a lock process in the first embodiment.

FIG. 4 is a diagram for explaining an example of description in a mail the portable information terminal receives in the first embodiment.

FIG. 5 is a flowchart showing a lock process according to a second embodiment of the invention.

FIG. 6 is a diagram for explaining an example of description in a mail the portable information terminal transmits in the second embodiment.

FIG. 7 is a flowchart showing a lock process according to a third embodiment of the invention.

FIG. 8 is a diagram for explaining an example of description in a mail the portable information terminal receives in the third embodiment.

FIG. 9 is a flowchart showing a lock process according to a fourth embodiment of the invention.

FIG. 10A is a diagram for explaining an example of description in a mail the portable information terminal receives in the fourth embodiment.

FIG. 10B is a diagram for explaining an example of description in a mail the portable information terminal transmits in the fourth embodiment.

FIG. 11 is a flowchart showing a certification information change process according to a fifth embodiment of the invention.

FIG. 12 is a flowchart showing a certification information change process according to a sixth embodiment of the invention.

FIG. 13 is a flowchart showing a certification information change process according to a seventh embodiment of the invention.

FIG. 14 is a diagram for explaining an example of description in a mail the portable information terminal receives in the seventh embodiment.

FIG. 15 is a flowchart showing a certification information change process according to an eighth embodiment of the invention.

FIG. 16 is diagram for explaining an example of description in a mail the portable information terminal receives in the eighth embodiment.

FIG. 17 is a flowchart showing a certification information change process according to a ninth embodiment of the invention.

FIG. 18 is diagram for explaining an example of description in a mail the portable information terminal receives in the ninth embodiment.

FIG. 19 is a flowchart showing a certification information change process according to a tenth embodiment of the invention.

FIG. 20 is diagram for explaining an example of description in a mail the portable information terminal receives in the tenth embodiment.

FIG. 21 is diagram for explaining another example of description in a mail the portable information terminal receives in the tenth embodiment.

### DESCRIPTION OF THE EMBODIMENTS

Embodiments of the present invention will now be described by making reference to the accompanying drawings

### Embodiment 1

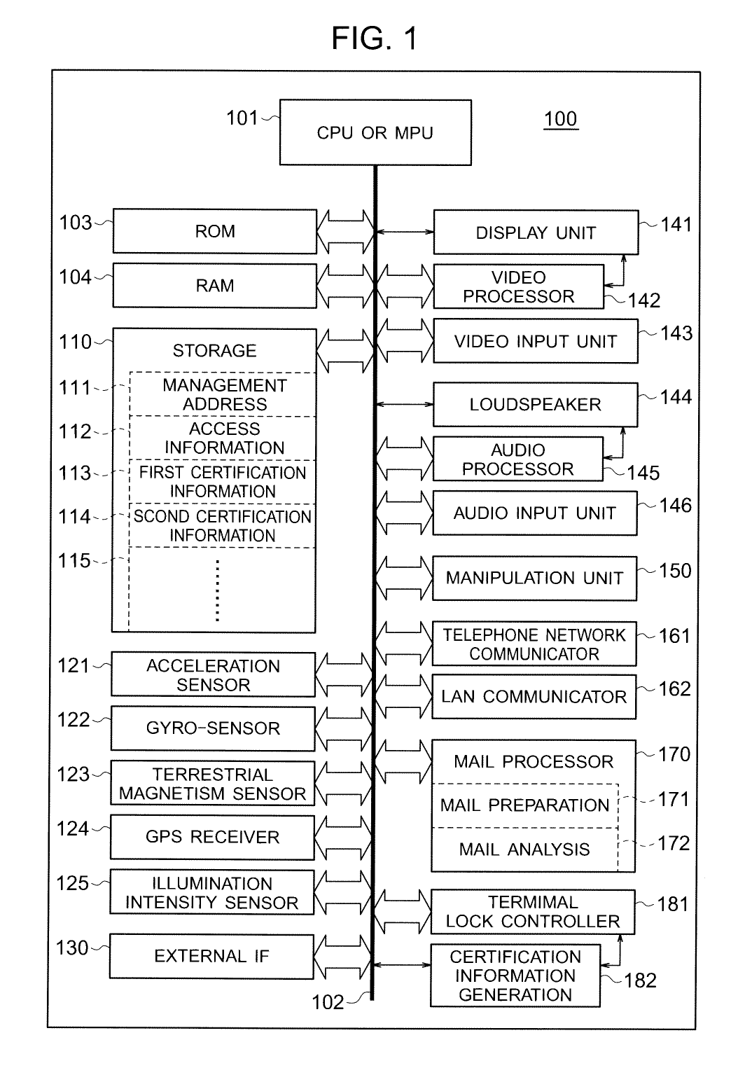

Referring first to FIG. 1, a portable information terminal according to the present embodiment is constructed as illustrated therein in block diagram form. The portable information terminal generally designated at 100 comprises a CPU or MPU 101, a system bus 102, a ROM 103, a RAM 104, a storage 110, an acceleration sensor 121, a gyro-sensor 122, a terrestrial magnetism sensor 123, a GPS receiver 124, an illumination intensity sensor 125, an external interface 130, a display unit 141, a display processor 142, a video input unit 143, a loudspeaker 144, a voice processor 145, a voice input unit 146, a manipulation unit 150, a telephone network communicator 161, a LAN communicator 162, a mail processor 170, a terminal lock controller 181 and a certification information generator 182.

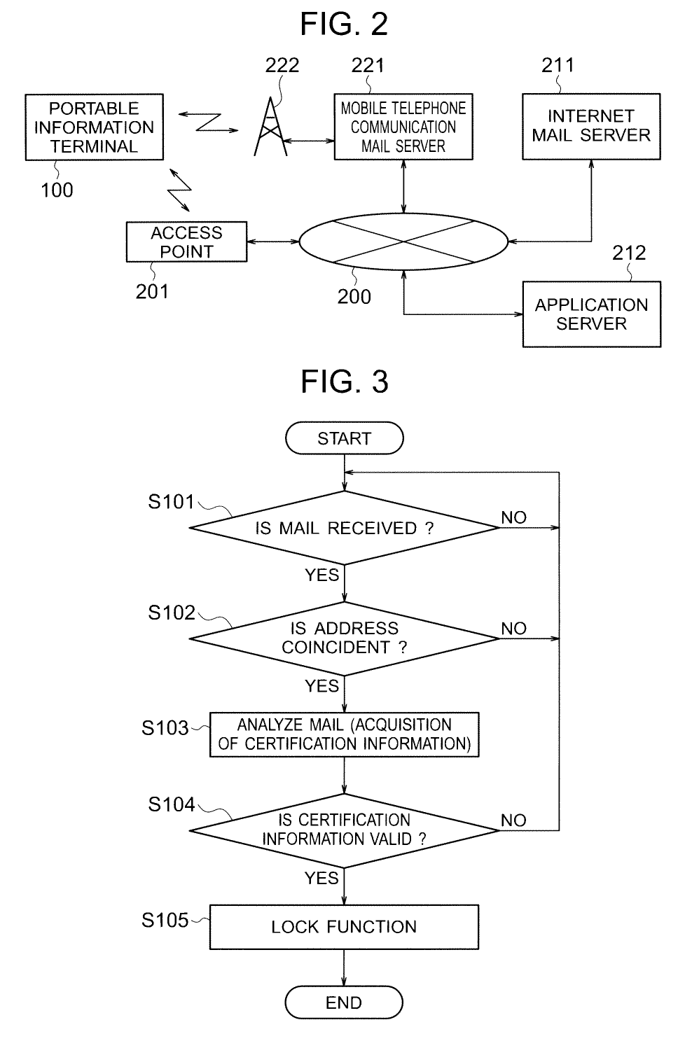

A communication system using the portable information terminal 100 according to the present embodiment is configured as illustrated in FIG. 2 so as to be constituted by the portable information terminal 100, an internet 200 along with its access point for radio communication 201, an internet mail server 211, an application server 212, a mobile telephone communication mail server 221 and a base station 222 of mobile telephone communication network.

As the portable information terminal 100, a pocket phone or smartphone, a PDA (Personal Digital Assistants) or handy type PC (Personal Computer) or a tablet PC may be employed. Also, a portable game machine, a digital camera or another type of portable digital device may be used.

The CPU or MPU 101 can be exemplified by a microprocessor adapted to control the whole of portable information terminal 100 The system bus 102 is a data communication path adapted for transmission and reception of data between the CPU or MPU 101 and each of the components included in the portable information terminal 100 The ROM (Read Only Memory) 103 is a memory stored with such a basic operation program for the basic operation of portable information terminal 100 as an operating system, a predetermined application program and the like and a rewritable ROM such as, for example. an EEPROM (Electrically Erasable Programmable ROM) or a flash ROM may be used by updating the program stored in the ROM 103, version-up and functional extension of the basic operation program can be achieved. It is to be noted that the ROM 103 may not be constituted independently in contrast to the illustration in FIG. 1 but may be materialized by using part of memory areas inside the storage 110. The RAM (Random Access Memory) 104 acts as a work area during execution of the basic operation program or the individual application programs. Alternatively, the ROM 13 and RAM 104 may be constituted integrally with the CPU or MPU 101.

The storage 110 stores various kinds of pieces of information such as individual values of operation setting of portable information terminal 100, personal data (address note, schedules and so on) of a possessor of portable information terminal 100 and the like. Specifically, the storage 110 has a management address storing area 111, an access inform anon storing area 112, a first certification information storing area 113, a second certification information storing area 114 and an other information storing area 115. The management address storing area 111, access information storing area 112, first certification information storing area 113 and second certification information storing area 114 will be described later in greater detail but all of these areas are not always necessary and in an embodiment, only part of the areas may be preserved. Further, part of areas of the other information storing area 115 may substitute for all or part of the functional area of ROM 103.

Furthermore, the portable information terminal 100 has its function which can be extended by down loading a new application from the application server 212 via the telephone network communicator 161 or LAN communicator 162 In this case, the down loaded application is stored in the other information storing area 115 of storage 110. By causing the application stored in the other information storing area 115 to be developed on the RAM 104 and to be executed during usage, the portable information terminal 100 can materialize various functions.

In case the present embodiment is offered in the form of a program, the program is down loaded from the application server 212, for instance, so that either the aforementioned program stored in the other information storing area 115 in storage 110 or the program which has been stored in the other information storing area 115 from the initial phase of operation of portable information terminal 110 may be developed on the RAM 104 and executed under the direction of the CPU or MPU 101, thus ensuring that advantageous effects of the present embodiment can be obtained.

It will be appreciated that even in the power-off condition of portable information terminal 100, the storage 110 must preserve the stored information. Accordingly, for example. a flash ROM, a SSD (Solid State Drive), a HDD (Hard Disc Drive) or the like is used as the storage 110.

Each of the acceleration sensor 121, gyro-sensor 122, terrestrial magnetism sensor 123 and GPS receiver 124 detects the status of portable information terminal 100. With the help of these sensors, the movement, tilt, position at present and direction of portable information terminal 100 can be detected. The illumination intensity sensor 125 detects the brightness in the neighborhood of the portable information terminal 100.

The external IF 130 is an interface for extending the function of portable information terminal 100 and is adapted to connect either a USB (Universal Serial Bus) device or a memory card or to connect a video cable adapted for displaying video images on an external monitor.

The display unit 141 is a display device in the form of a liquid crystal panel, for instance, and operates to offer, to the possessor of portable information terminal 100, video signals processed in the display processor 142. The video input unit 143 is a camera capable of inputting a moving video or still video. The loudspeaker 144 offers voice signals processed in the voice processor 145 to the possessor of portable information terminal 100. The voice input unit 146 is a microphone and inputs voice data such as voice of the possessor.

The manipulation unit 150 inputs instructions on the basis of operation by the user so as to act as an instruction input device which inputs characters or manipulates an application put into execution. The manipulation unit 150 may be materialized by such a multi-key having button switches arrayed or a touch-panel overlaid on the display 141. Also, both the components may be used in combination. A voice input obtained by utilizing the audio input unit 146 may be in association with the multi-key and touch-panel.

The telephone network communicator 161 communicates with the base station 222 in mobile telephone communication network. The LAN (Local Area Network) communicator 162 conducts communications by way of the access point 201 for radio communication and pursuant to Wi-Fi (registered trademark) of internet 200. Alternatively, the LAN communicator 162 may communicate with the Internet 200 through wire communication. Each of the telephone network communicator 161 and LAN communicator 162 is constituted by an antenna, a modulator and a de-modulator.

The mail processor 170 is constituted by a microprocessor so as to execute control of mail transmission and reception and besides, preparation of mail (171) and analysis of mail (172). While the mail processor 170 is illustrated as an independent component in FIG. 1, the same function may be materialized when the CPU or MPU 101 executes a predetermined program by using the RAM 104 as a work area and the other information storing area 115 of storage 110 as a matt preserving area.

The terminal lock controller 181 is constituted by a microprocessor so as to control limiting a predetermined function or operation of the portable information terminal 100 (hereinafter, referred to as “functional lock”) so that for example, even when the manipulation unit 150 accepts an operation by the user, the acceptance can be deemed as being invalid, causing the CPU or MPU 101 not to carry out any process pursuant to the manipulation. The terminal lock controller 181 need not always limit all of the functions the portable information to final 100 has and only part of the functions may be limited. The certification information generator 182 is constituted by a microprocessor having the function to generate random numbers and it operates to generate certification information used for controlling the functional lock, The certification information generated by the certification information generator 182 takes the form of a random character string having a relatively large digit number (for example, 18 digits). The terminal lock controller 181 and certification information generator 182 will be described in greater detail in connection with embodiments to be described later, The terminal lock controller 181 may not be the independent component in contrast to the illustration in FIG. 1 but the CPU or MPU 101 may substitute therefor. Further, the certification information generator 182 need not always be necessary but may be omitted depending on an embodiment.

In the present embodiment, under the condition that the functional lock has been set up under the control of the terminal lock controller 181, the portable information terminal 100 does not accept direct manual operation excepting ON/OFF of the power source and operation for unlocking the functional lock. But, search for the base station and an access point, mail check during power source-on and other functions automatically executed without resort to manual operation may be rendered valid appropriately.

In the construction of portable information terminal 100 as shown in FIG. 1, many constituents including the individual sorts of sensors (121˜125) which are not indispensable for the present embodiment are also contained. Even with the dispensable constituents removed, features and meritorious effects of the present embodiment will not be impaired. Further, in respect of the telephone network communicator 161 and LAN communicator 162, for instance, provision of any one of them suffices. In an alternative, constituents not illustrated in FIG. 1 such as for television broadcast reception function, electronic money settlement and the like may be added.

In the portable information terminal 100 according to the present embodiment, reception of mails is carried out in accordance with procedures as below.

A mail transmitted from another mail transmitter to a mail address for mobile telephone network communication of the portable information terminal 100 is first stored in the mobile telephone communication mail server 221 on internet 200 The mobile telephone communication mail server 221 in receipt of the mail transmitted to the mail address for mobile telephone network communication of the portable information terminal 100 informs the portable information terminal 100 of the reception of the mail by way of the base station 222. When receiving the report from the mobile telephone communication mail server 221, the portable information terminal 100 acquires the mail from the mobile telephone communication mail server 221 through the medium of the base station 222 and telephone network communicator 161.

On the other hand, a mail transmitted from still another mail transmitter to a mail address for internet of the portable information terminal 100 is first stored in the internet mail server 211 on internet 200. At the time of power source throw-in and periodically at intervals of a predetermined time or in response to a request from the possessor of portable information terminal 100, the portable information terminal 100 confirms, via the LAN communicator 162 and access point 201 the internet mail server 211 as to whether a mail destined for the mail address for internet of the portable information terminal 100 is present. In the presence of the mail destined for the portable information terminal 100, the mail is acquired through the medium of the access point 201 and LAN communicator 162.

Turning now to FIG. 3, a flowchart of a lock process for executing functional lock of the portable information terminal 100 in the present embodiment is illustrated therein.

In the present embodiment, it is not always necessary to provide the access information storing area 112, first certification information storing area 113 and second certification information storing area 114 in the storage 110 and the certification information generator 182 which are illustrated in the block diagram in FIG. 1.

In using the portable information terminal 100 according to the present embodiment, the possessor registers in advance one or a plurality of management mail addresses which are used for admitting remote operation of controlling the functional lock of portable information terminal 100. Registration of the management mail addresses is dealt with by storing, in the management address storing area 111 of storage 110, numerals and characters inputted on the basis of the terminal operation accepted by the manipulation unit 150. In the event that the possessor of portable information terminal 100 loses the portable information terminal 100 after the process of registering the management mail addresses has finished, the possessor of portable information terminal 100 can control the functional lock of portable information terminal 100 by carrying out remote control through the use of the registered management mail address. The portable information terminal 100 in the present embodiment operates as will be described below.

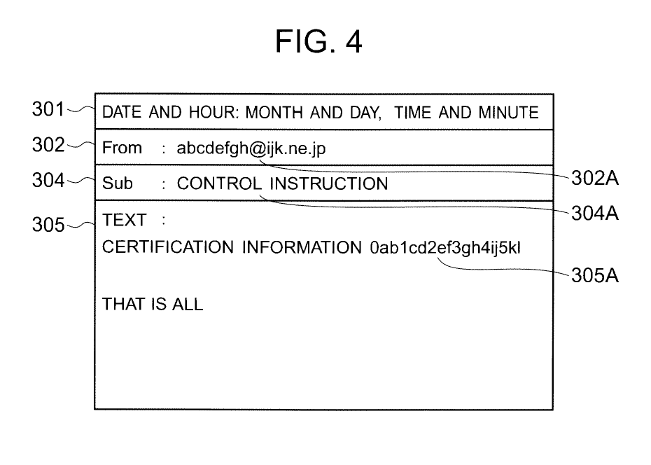

During ordinary operation, the portable information terminal 100 is placed in condition of awaiting reception of mails (hereinafter, referred to as “mail reception awaiting condition”) and the mail processor 170 checks at intervals of a predetermined time in step 101 that reception of a mail is present. If the absence of mail reception is determined in the step 101, the portable information terminal returns to the mail reception awaiting condition and the mail processor 170 again waits for a lapse of the predetermined time. If the presence of mail reception is determined in the step 101, the CPU or MPU 101 compares, in step 102, the management mail address stored in the management address storing area 111 with a mail address (302A in FIG. 4) of the originator of transmission of the received mail address. When in the step 102 the management mail address stored in the management address storing area 111 does not coincide with the mail address of the mail transmission originator, the program returns to the mail reception awaiting condition and the mail processor 170 again waits for a lapse of the predetermined time.

When in the step 102 the mail address for management stored in the management address storing area 111 coincides with the mail address of mail transmission originator of the received mail, the mail analyzer 172 inside mail processor 170 analyzes, in step 103, the contents of the received mail and conducts acquisition of certification information (305A in FIG. 4). If the certification information cannot be acquired or the acquired certification information is invalid (for example, in an improper format) in this phase, the portable information terminal 100 returns to the mail reception awaiting condition in step 104. When the acquired certification information is valid, the terminal lock controller 181 uses the acquired certification information to perform, in step 105, the functional lock for limiting the individual functions of the portable information terminal 100. The functional lock of the portable information terminal 100 can be unlocked by the acquired certification information. As exemplified in FIG. 4, the received mail has a description of certification information (305A) in a text display 305 of mail.

Analyzing the contents of the received mail and acquiring the certification information in the step 103 may be carried out when the received mail has a prescribed format, for example, only when a statement of “control instruction” (304A) is present in a title display 304 of mail as shown in the example of FIG. 4 By doing so, an ordinary mail not intending functional lock of portable information terminal 100 can be transmitted from the management mail address stored in the management address storing area 111 to the portable information terminal 100. If in the above case the statement control instruction is not given in the title display 304 of mail, the program returns, of course, to the mail reception awaiting condition.

As described above, according to the portable information terminal 100 in the present embodiment, when losing the portable information to final 100, the possessor can luck the function of the portable information terminal 100 by performing remote operation through mail by using the management mail address registered in advance. Further, the possessor of portable information terminal 100 can unlock anytime the functional lock of the portable information terminal 100 by using certification information the possessor designates. Then the possessor of portable information terminal 100 can improve the security in the event of losing the portable information terminal 100 by designating as the certification information for unlocking the functional lock a character string of many digits, for instance

### Embodiment 2

Second embodiment of the present invention will now be described. It will be appreciated that the construction and advantageous effects in the present embodiment are identical to those in embodiment 1 unless they are described to the contrary. Therefore, in the following description, differences between the present embodiment and embodiment 1 will be described principally and for avoidance of prolixity of description, a description to be given to common points will be omitted as far as possible.

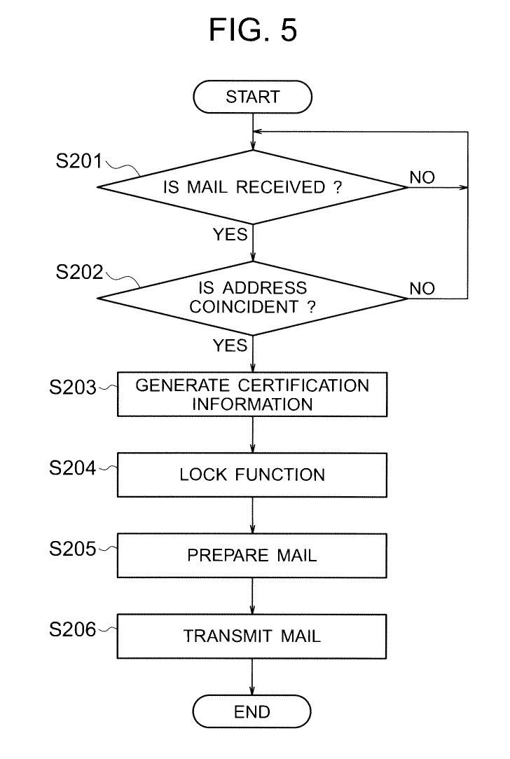

Illustrated in FIG. 5 is a flowchart showing a lock process in the present embodiment in which a portable information terminal 100 in the present embodiment executes the lock process in FIG. 5 in place of the lock process described by using the flowchart shown in FIG. 3

To add, in the present embodiment, the access information storing area 112, first certification information storing area 113 and second certification information storing area 114 in the storage 110 illustrated in the block diagram in FIG. 1 need not always be provided.

In using the portable information terminal 100 according to the present embodiment, the possessor registers in advance one or a plurality of management mail addresses used for admitting g remote operation of controlling the functional lock of portable information terminal 100. When losing the portable information terminal 100 under the condition that the process of registering the management mail addresses has been finished, the possessor of the portable information terminal 100 can control the functional lock of the portable information terminal 100 through remote operation by using the registered management mail address. The portable information terminal 100 according to the present embodiment operates as will be described below.

During normal operation, the portable information terminal 100 is placed in the mail reception awaiting, condition and the presence or absence of mail reception is checked at intervals of a predetermined time in step 201 When the absence of mail reception is determined in the step 201, the program returns to the mail reception awaiting condition and the mail processor 170 again waits for a lapse of the predetermined time When the presence of reception of a mail is determined in the step 201, the CPU or MPU 101 compares, in step 202, the management mail address stored in the management address storing area 111 with a mail address of the originator of transmission of the received mail. When in the step 202 the management mail address stored in the management address storing area 111 does not coincide with the mail address of the originator of transmission of the received mail, the program returns to the mail reception awaiting condition and the mail processor 170 again waits for a lapse of the predetermined time When in the step 202 the management mail address stored in the management address storing area 111 coincides with the mail address of the originator of transmission of the received mail, the CPU or MPU 101 causes, in step 203, the certification information generator 182 to generate certification information and also causes, in step 204. the terminal lock controller 181 to perform the functional lock by using the generated certification information in order to limit the individual functions of the portable information terminal 100. The functional lock of portable information terminal 100 can be unlocked by using the generated certification information as above.

In conducting the process in the step 204 for limiting the individual functions of portable information terminal 100 by using the generated certification information when the received mail has a prescribed format, the process may be executed only when, for example, a title display 304 of mail has a statement “control instruction”. By doing so, it is possible to transmit an ordinary mail not intending the functional lock of the portable information terminal 100 from the arrangement mail address stored in the management address storing area 111 to a portable information terminal 100. If in the above case the title display 304 of mail lacks a statement “control instruction”, the program returns, of course, to the mail reception awaiting condition.

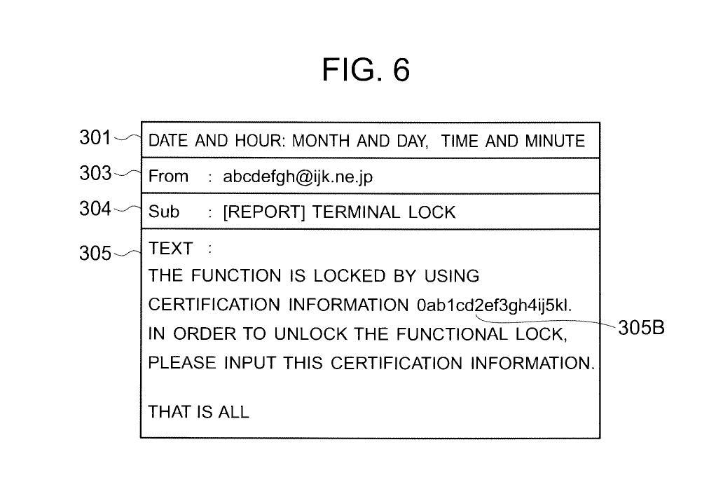

In addition, after the process for the functional lock of portable information terminal 100 in the step 204 has been finished, the mail preparer 171 in mail processor 170 prepares, in step 205, a mail used for informing the possessor of the fact that the functional lock of portable information terminal 100 has been executed and besides, transmits, in step 206, a mail destined for the mail address of the originator of transmission of the received mail (namely, the management mail address stored in the management address storing area 111). It is to be noted that the mail prepared as above is described with at least the certification information generated in the step 203. An example of the mail prepared in the step 205 is illustrated in Fig. 6. the FIG. 6 example, the generated certification information (305B) and an indication purporting that the functional lock of portable information terminal 100 has been executed are described in a text display 305 of the prepared mail.

As described above, according to the portable information terminal 100 in the present embodiment, in the event of loss of the portable information terminal 100, the possessor can perform the functional lock of the portable information terminal 100 through remote operation based on mail by using the management mail address registered in advance. Further, since the possessor of the portable information terminal 100 capable of making reference to a mail destined for the management mail address can know through mail the certification information used for the functional lock of the portable information terminal 100, the possessor can anytime unlock the functional lock of the portable information terminal 100. In addition, even when certification information having shortened digits (for example, a numerical string of 4 digits) is set for the sake of convenience during ordinary operation, the functional lock of the portable information terminal 100 can be executed in the event of the loss by using certification information having increased digits (for example, an alphanumeric string of 18 digits) and therefore, the security can be promoted in the event of loss of the portable information terminal 100.

### Embodiment 3

Third embodiment of the present invention will now be described. It will be appreciated that the construction and advantageous effect in the present embodiment are also identical to those in embodiment 1 unless they are described to the contrary. Therefore, in the following description, differences between the present embodiment and embodiment 1 will be described principally.

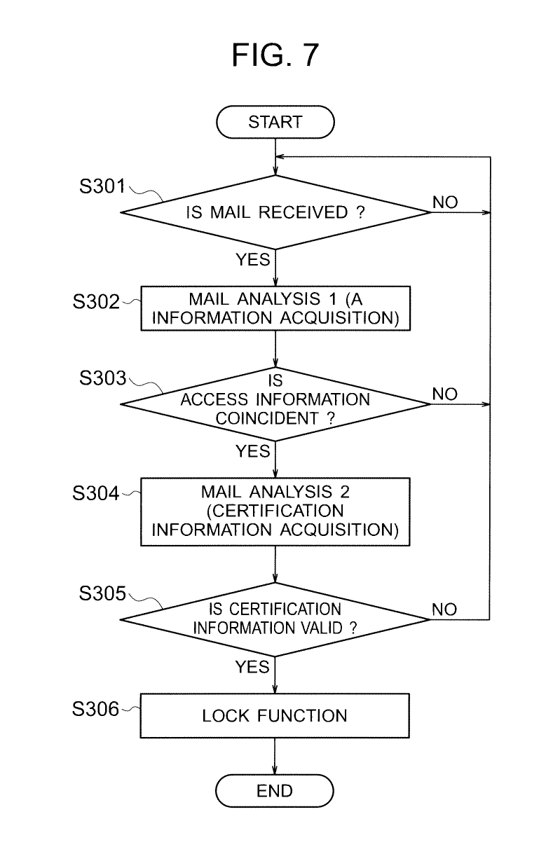

Illustrated in FIG. 7 is a flowchart showing a lock process in the present embodiment.

To add, in the present embodiment, the management address storing area 111, first certificate information storing area 113 and second certification information storing area 114 in the storage 110 and the certification information generator 182 which are illustrated in the block diagram in FIG. 1 need not always be provided.

In using the portable information terminal 100 according to the present embodiment, the possessor registers in advance access information used for admitting remote operation of controlling the functional lock of portable information terminal 100. It is to be noted that registering the access information is executed by storing, in the access information storing area 112 of storage 110, numerals and characters which are inputted on the basis of the terminal operation the manipulation unit 150 accepts. When losing the portable information terminal 100 under the condition that the above registering process of the access information has ended, the possessor of the portable information terminal 100 can control the functional lock of the portable information terminal 100 through remote operation by using the registered access information. The portable information terminal 100 in the present embodiment operates as will be described below.

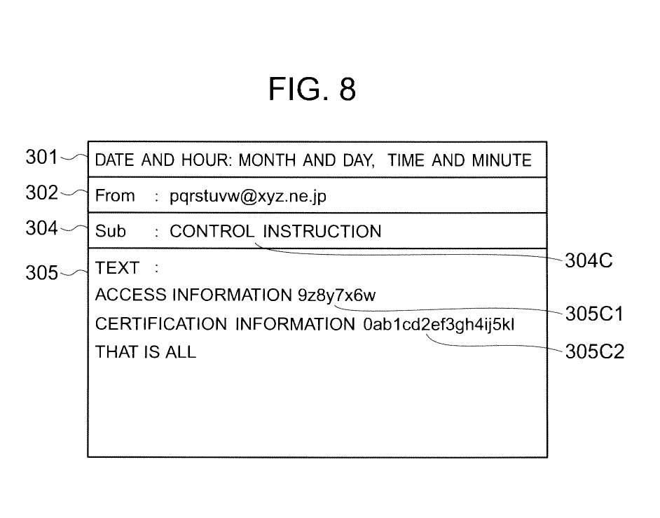

During normal operation, the portable information terminal 100 is placed in the mail reception awaiting condition and the presence or absence of mail reception is checked at intervals of a predetermined time under the control of mail processor 170 in step 301. When the absence of mail reception is determined in the step 301, the program returns to the mail reception awaiting condition and the mail processor 170 again waits for a lapse of the predetermined time. When the presence of reception of a mail is determined in the step 301, the mail analyzer 172 in mail processor 170 analyzes the contents of the received mail and if the access information is described in the received mail, acquisition of the access information (305C1 in FIG. 8) is carried out in step 302. Further, the CPU or MPU 101 compares, in step 303, the access information stored in the access information storing area 112 with the access information acquired from the received mail. When the access information stored in the access information storing area 112 does not coincide with the access information acquired from the received mail (inclusive of failure to acquire the access information in the step 302), the program returns to the mail reception awaiting condition and the mail processor 170 again awaits a lapse of the predetermined time. When the access information stored in the access information storing area 112 coincides with the access information acquired from the received mail in the step 303, the mail analyzer 172 in mail processor 170 analyzes the contents of the received mail and acquires certification information (305C2 in FIG. 8) in step 304. If in this phase, the certification information cannot be acquired or the acquired certification information is invalid in step 305, the portable information terminal 100 returns to await reception of mail When the acquired certification information is valid, the terminal lock controller 181 uses the acquired certification information to execute, in step 306, the functional lock for limiting the individual functions of the portable information terminal 100, The functional lock of portable information terminal 100 can be unlocked by the acquired certification information. It is to be noted that the received mail has a text display 305 of mail in which access information (305C1) and certification information (305C2) are described as exemplified in FIG. 8.

Further, analyzing the contents of the received mail and acquiring the access information and the certification information in the steps 302 and 304 may be dealt with only when the received mail has a prescribed format, for example, a statement “control instruction” (304C) in a title display 304 of mail as exemplified in FIG. 8. By doing so, useless analysis of the contents of an ordinary mail which is not described with access information and certification information so as not to intend the functional lock of portable information terminal 100 can be omitted. In the case as above, when the title display 304 of mail lacks the statement “control instruction”, the program returns, needless to say, to the mail reception awaiting condition.

As described above, according to the portable information terminal 100 in the present embodiment, when losing the portable information terminal 100, the possessor can perform the functional lock of the portable information terminal 100 through remote operation based on mail by using the access information registered in advance, Also, the possessor of the portable information terminal 100 can anytime unlock the functional lock of the portable information terminal by using the certification information the possessor has designated for the purpose of executing the functional lock. Further, the possessor can intensify the security of the portable information terminal 100 by using any mail transmission device having mail addresses which can transmit a mail including access information and accordingly, the lapse of time and load consumed before starting the use of the mail transmission device for remote operation of the portable information terminal 100 can be alleviated.

### Embodiment 4

The fourth embodiment of the present invention will now be described. It will be appreciated that the construction and advantageous effect in the present embodiment are also identical to those in embodiment 1 unless they are described to the contrary. Therefore, in the following description, differences between the present embodiment and embodiment 1 will be described principally.

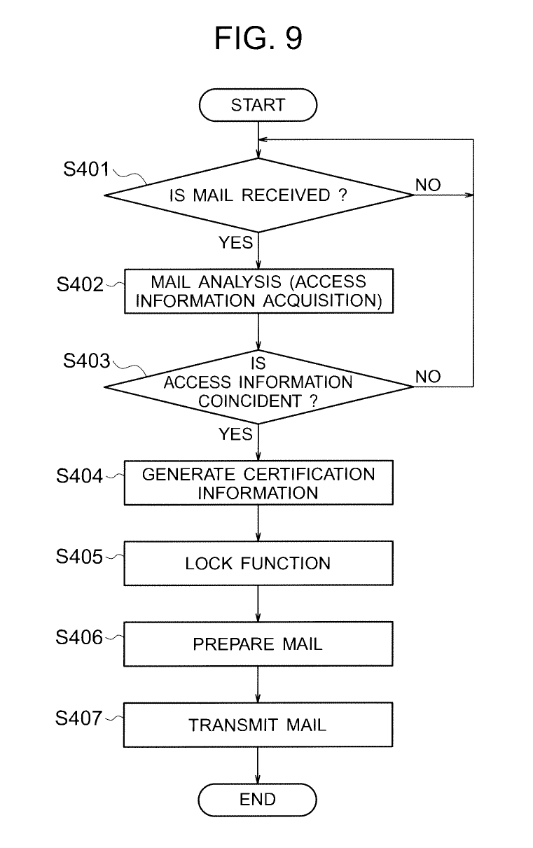

Illustrated in FIG. 9 is a flowchart showing a lock process in the present embodiment.

To add, in the present embodiment, the management address storing area 111, first certification information storing area 113 and second certification information storing area 114 in the storage 110 illustrated in the block diagram in FIG. 1 need not always be provided.

In using the portable information terminal 100 according to the present embodiment, the possessor registers in advance access information used for admitting remote operation of controlling, the functional lock of portable information terminal 100. When losing the portable information terminal 100 under the condition that the registering process of the access information has ended, the possessor of the portable information terminal 100 can control the functional lock of the portable information terminal 100 through remote operation by using the registered access information. The portable information terminal 100 in the present embodiment operates as will be described below.

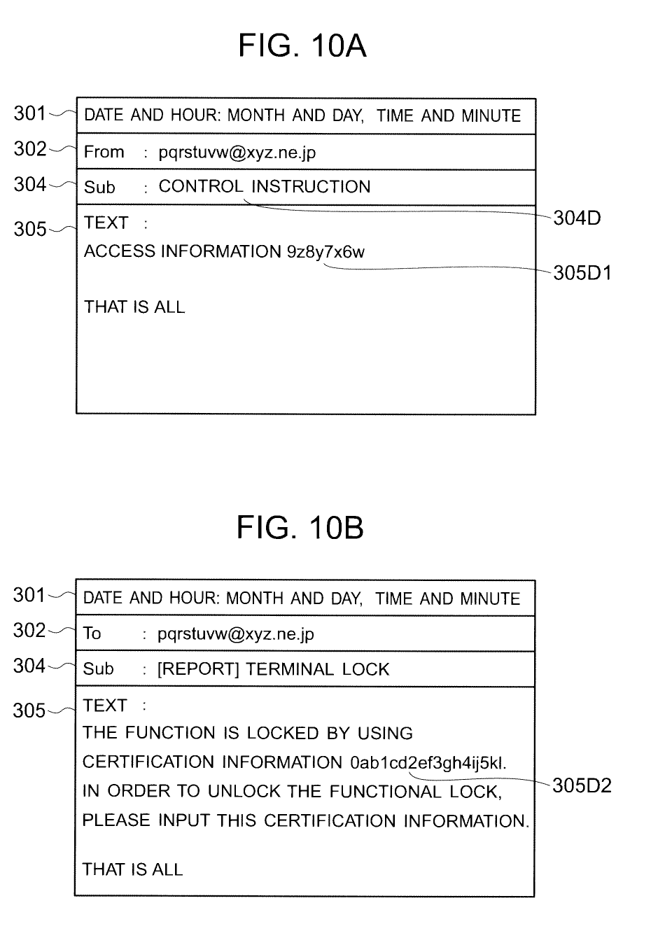

During normal operation, the portable information terminal 100 is placed in the mail reception awaiting condition and the presence or absence of mail reception is checked at intervals of a predetermined time in step 401. When the absence of mail reception is determined in the step 401, the program returns to the mail reception awaiting condition and the mail processor 170 again waits for a lapse of the predetermined time. When the presence of reception of a mail is determined in the step 401, the mail analyzer 172 in mail processor 170 analyzes the contents of the received mail and if the access information is described in the received mail, acquisition of the access information (305D1 in FIG. 10A) is carried out in step 402. Further, the CPU or MPU 101 compares, in step 403, the access information stored in the access information storing area 112 with the access information acquired from the received mail. When the access information stored in the access information storing area 112 does not coincide with the access information acquired from the received mail (inclusive of failure to acquire the access information in the step 402), the program returns to the mail reception awaiting condition and the mail processor 170 again waits for a lapse of the predetermined time. When the access information stored in the access information storing area 112 coincides with the access information acquired from the received mail in the step 403, the CPU or MPU 101 causes, in step 404, the certification information generator 182 to generate certification information and besides, causes, in step 405, the terminal lock controller 181 to perform the functional lock of portable information terminal 100 by using the generated certification information. The functional lock of portable information terminal 100 can be unlocked by the generated certification information. It is to be noted that the received mail has a text display 305 of mail in which access information (305D1) is described as exemplified in FIG. 10A.

In addition, after the process for the functional lock of portable information terminal 100 in the step 405 has been finished, the mail preparer 171 in mail processor 170 prepares, in step 406, a mail which is used to inform the execution of functional lock of the portable information terminal 100 and besides, transmits, in step 407, a mail destined for the mail address of the originator of transmission of the received mail by way of the telephone network communicator 161 or LAN communicator 162. It is to be noted that the mail prepared as above is described with at least the certification information generated in the step 404. An example of the mail prepared in the step 406 is illustrated in FIG. 10B. In the FIG. 10B example, the generated certification information (305D2) and an indication purporting that the functional lock of portable information terminal 100 has been executed are described in a text display 305 of the prepared mail.

In conducting the process in the step 402 for analyzing the contents of the received mail and acquiring the access information when the received mail has a prescribed format, the process may be executed only when, for example, a title display 304 of mail has a statement “control instruction” (304D) as exemplified in FIG. 10A, By doing so, useless execution of the content analysis of an ordinary mail lacking the description of access information so as not to intend the functional lock of the portable information terminal 100 can be omitted. In the above, in the absence of the statement “control instruction” in the title display 304 of mail, the program of course returns to the mail reception awaiting condition.

As described above, according to the portable information to terminal 100 in the present embodiment, when losing the portable information terminal 100, the possessor can perform the functional lock of the portable information terminal 100 by using the access information registered in advance through remote operation based on mail. Also, the possessor of the portable information terminal 100 can receive the certification information used for the functional lock of the portable information terminal through mail and therefore, can unlock anytime the functional lock of the portable information terminal 100. Further, the possessor can intensify the security of the portable information terminal 100 by using any mail transmission device having mail addresses.

### Embodiment 5

The fifth embodiment of the present invention will now be described. It will be appreciated that the construction and advantageous effects in the present embodiment are also identical to those in embodiment 1 unless they are described to the contrary. Therefore, in the following description, differences between the present embodiment and embodiment 1 will be described principally.

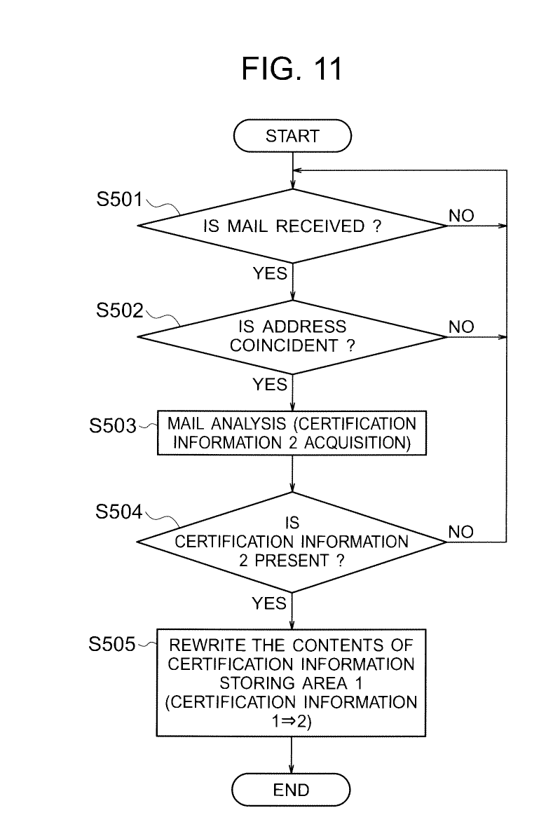

Illustrated in FIG. 11 is a flowchart showing a certification information changing process in the present embodiment for changing the certification information used for the functional lock of portable information terminal 100 (or for its unlocking).

To add, in the present embodiment, the access information storing area 112 and second certification information storing area 114 in the storage 110 and the certification information generator 182 which are illustrated in the block diagram in FIG. 1 need not always be provided.

In using the portable information terminal 100 according to the present embodiment, the possessor registers in advance one or a plurality of management mail addresses used for admitting remote operation of controlling the functional lock of portable information terminal 100. The functional lock of the portable information terminal 100 has been executed by using the first certification information stored in the first certification information storing area 113 in the storage 110, and the functional lock of the portable information terminal 100 can be unlocked by the first certification information. To add, the first certification information is a PIN of numerical string of about 4 digits (0123, for instance) or the like.

When losing the portable information terminal 100 under the condition as above, the possessor of the portable information terminal 100 can execute the functional lock of the portable information terminal 100 through remote operation by using the registered management mail address. The portable information terminal 100 in the present embodiment operates as will be described below.

During normal operation, the portable information terminal 100 is placed in the mail reception awaiting condition and the presence or absence of mail reception is checked at intervals of a predetermined time in step 501. When the absence of mail reception is determined in the step 501, the program returns to the mail reception awaiting condition and the mail processor 170 again waits for a lapse of the predetermined time. When the presence of reception of a mail is determined in the step 501, the CPU or MPU 101 compares the management mail address stored in the management address storing area 111 with a mail address of the originator of transmission of the received mail in step 502. When in the step 502 the management mail address stored in the management address storing area 111 does not coincide with the mail address of the originator of transmission of the received mail, the program returns to the mail reception awaiting condition and the mail processor 170 again waits for a lapse of the predetermined time. When in the step 502 the management mail address stored in the management address storing area 111 coincides with the mail address of the originator of transmission of the received mail, the mail analyzer 172 in mail processor 170 analyzes the contents of the received mail and acquires certification information in step 503. If, in this phase the certification information cannot be acquired or the acquired certification information is invalid, the portable information terminal 100 returns, in step 504, to wait for mail reception. When the acquired certification information is valid, the terminal lock controller 181 changes, in step 505, the information stored in the first certification information storing area 113 from the first certification information to the acquired certification information. Though this process, the functional lock of the portable information terminal 100 is made unable to be unlocked by the first certification information but can be unlocked by only the certification information acquired from the received mail The received mail may have the same format as that exemplified in FIG. 4. Certification information 305A described in a text display 305 of mail becomes new certification information in the portable information terminal 100.

Further, analyzing the contents of the received mail and acquiring the certification information in the step 503 may be dealt with only when the received mail has the prescribed format, for example, a statement “control instruction” in a title display 304 of mail. By doing so, an ordinary mail not intending the functional lock of the portable information terminal 100 can be transmitted from the management mail address stored in the management address storing area 111 to the portable information terminal 100. In the case as above, when the title display 304 of mail lacks the statement “control instruction” the program returns, needless to say, to the mail reception await condition.

As described above, according to the portable information terminal 100 in the present embodiment, when losing the portable information terminal 100, the possessor can control the functional lock of the portable information terminal 100 through remote operation based on mail by using the management mail address registered in advance, Also, the possessor of the portable information terminal 100 can change the certification information used for the functional lock of the portable information terminal from simple one (in the present embodiment, a PIN of a numerical string of about 4 digits) to sophisticated information the possessor designates, thus permitting the security to be improved in the event of lost of the portable information terminal 100. Further, the possessor can anytime unlock the functional lock of portable information terminal by using the certification information the possessor has designated.

### Embodiment 6

The sixth embodiment of the present invention will now be described. It will be appreciated that the construction and advantageous effects in the present embodiment are also identical to those in embodiment 1 unless they are described to the contrary. Therefore, in the following description, differences between the present embodiment and embodiment 1 will be described principally.

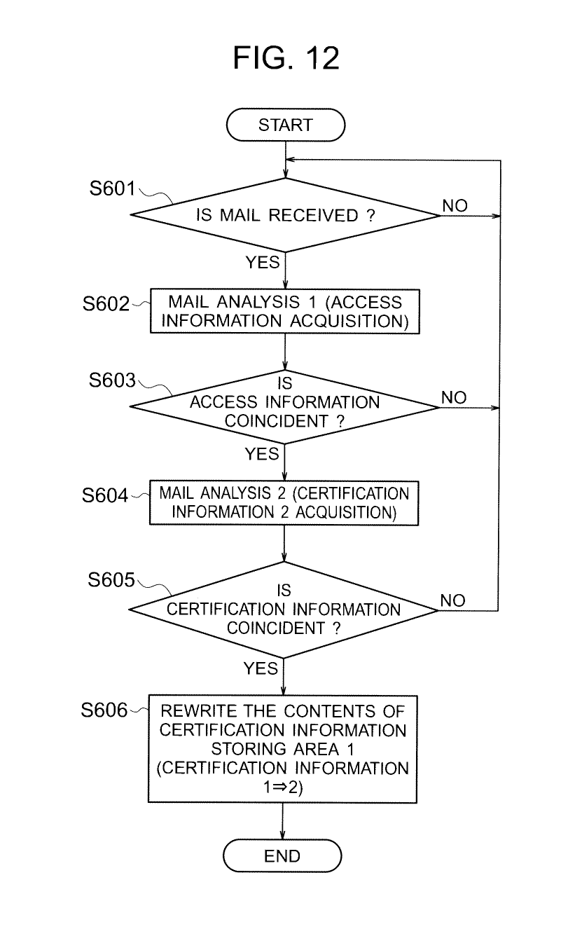

Illustrated in FIG. 12 is a flowchart showing a certification inform anon changing process in the present embodiment.

To add, in the present embodiment, the management address storing area 111 and second certification information storing area 114 in the storage 110 and the certification information generator 182 which are illustrated in the block diagram in FIG. 1 need not always be provided.

In using the portable information terminal 100 according to the present embodiment, the possessor registers in advance access information used for admitting remote operation of controlling the functional lock of portable information terminal 100. The functional lock of the portable information terminal 100 has been executed by using the first certification information stored in the first certification information storing area 113 in the storage 110 and the functional lock of the portable information terminal 100 can be unlocked by the first certification information. To add, the first certification information is a PIN of a numerical string of about 4 digits (for example, 0123) or the like.

When losing the portable information terminal 100 under the condition as above, the possessor of the portable information terminal 100 can execute the functional lock of the portable information terminal 100 through remote operation by using the registered access information. The portable information terminal 100 in the present embodiment operates as will be described below.

During normal operation, the portable information terminal 100 is placed in the mail reception awaiting condition and under the control of the mail processor 170, the presence or absence of mail reception is checked at intervals of a predetermined time in step 601 When the absence of mail reception is determined in the step 601, the program returns to the mail reception awaiting condition and the mail processor 170 again waits for a lapse of the predetermined time When the presence of reception of a mail is determined in the step 601, the mail analyzer 172 in mail processor 170 analyzes the contents of the received mail and when the received mail is described with access information, the access information is acquired in step 602. Further, the CPU or MPU 101 compares, in step 603, the access information stored in the access information storing area 112 with the access information acquired from the received mail. When in the step 603 the access information stored in the access information storing area 112 does not coincide with the access information acquired from the received mail (inclusive of failure to acquire access information in the step 602), the program returns to the mail reception awaiting condition and the mail processor 170 again waits for a lapse of the predetermined time

When, in the step 603, the access information stored in the access information storing area 112 coincides with the access information acquired from the received mail, the mail analyzer 172 in mail processor 170 analyzes, in step 604, the contents of the received mail and acquires certification information described in the mail. If, in this phase, the certification information cannot be acquired or the acquired certification information is invalid. the portable information terminal 100 returns to wait for mail reception in step 605 When the acquired certification information is valid, the terminal lock controller 181 changes, in step 606, the information stored in the first certification information storing area 113 from the first certification information to the certification information acquired from the received mail. Though this process, the functional lock of the portable information terminal 100 is made unable to be unlocked by the first certification information but can be unlocked by only the certification information acquired from the received mail. The received mail may have the same format as that exemplified in FIG. 8. Certification information 305C2 described in a text display 305 of mail becomes new certification information in the portable information terminal 100.

Further, analyzing the contents of the received mail and acquiring access information and certification information in the steps 602 and 604 may be dealt with only when the received mail has the predetermined format having, for example, a statement “control instruction” described in a title display 304 of mail. By doing so, useless analysis of the contents of an ordinary mail which is not described with access information and certification information so as not to intend the functional lock of portable information terminal 100 can be omitted. In the case as above, when the title display 304 of mail lacks the statement “control instruction”, the program returns, needless to say, to the mail reception awaiting condition.

As described above, according to the portable information terminal 100 in the present embodiment, when losing the portable information terminal 100, the possessor can control the functional lock of the portable information terminal 100 through remote operation based on mail by using the access information registered in advance. Also, the possessor of the portable information terminal 100 can change the certification information used for the functional lock of the portable information terminal from simple one (in the present embodiment, a PIN of a numerical string of about 4 digits) to sophisticated information the possessor designates, thus permitting the security to be improved in the event of lost of the portable information terminal 100. Further, the possessor can any time unlock the functional lock of the portable information to terminal by using the certification information the possessor designates. Furthermore, the possessor can change the certification information used for unlocking the functional lock of portable information terminal 100 by using any mail transmission device having mail addresses and accordingly, the lapse of time and load consumed before starting the use of the mail transmission device for remote operation of the portable information terminal 100 can be alleviated.

### Embodiment 7

The seventh embodiment of the present invention will now be described. It will be appreciated that the construction and advantageous effects in the present embodiment are also identical to those in embodiment 1 unless they are described to the contrary. Therefore, in the following description, differences between the present embodiment and embodiment 1 will be described principally.

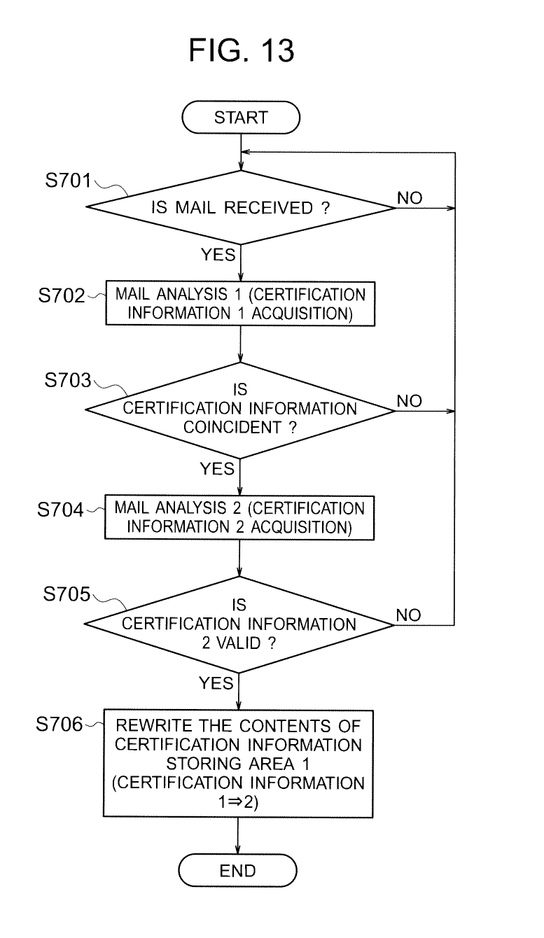

Illustrated in FIG. 13 is a flowchart showing a certification information changing process in the present embodiment.

To add, in the present embodiment, the management address storing area 111, access information storing area 112 and second certification information storing area 114 in the storage 110 and the certification information generator 182 which are illustrated in the block diagram in FIG. 1 need not always be provided.

A description will be given under the condition that in the portable information terminal 100 according to the present embodiment, the functional lock has been executed by first certification information stored in the first certification information storing area 113. The functional lock of portable information terminal 100 can be unlocked by the first certification information. Further, the first certification information is assumed to be a PIN of a numerical string of about 4 digits (for example, 0123) or the like in the present embodiment.

When losing the portable information terminal 100 under the condition as above, the possessor of the portable information terminal 100 can control through remote operation the functional lock of the portable information terminal 100 by using the first certification information. The portable information terminal 100 in the present embodiment operates as will be described below.

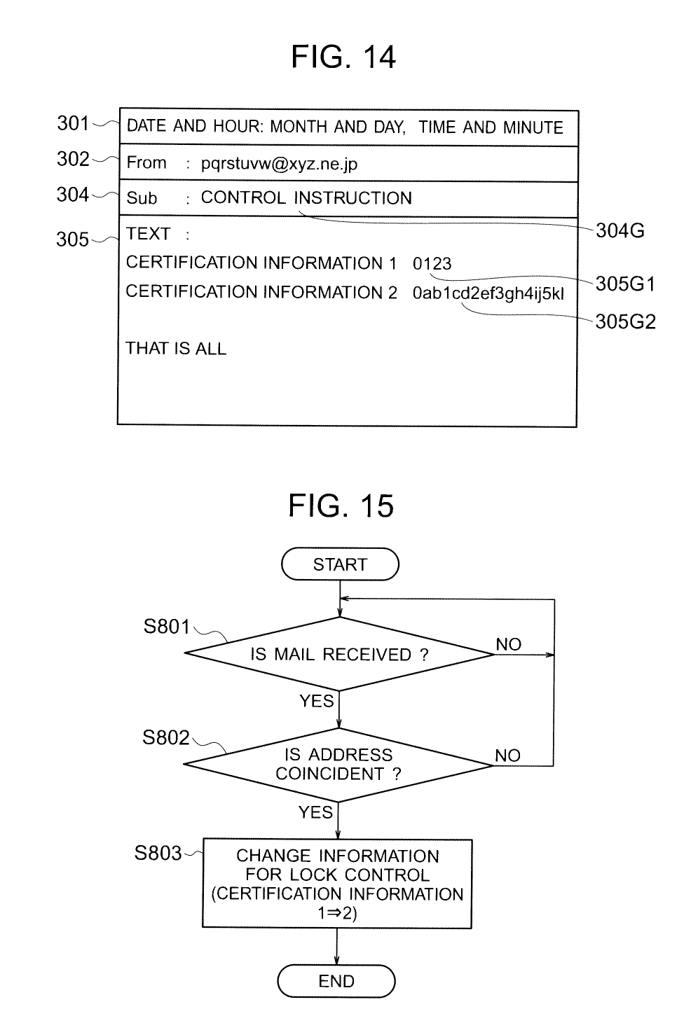

During normal operation, the portable information terminal 100 is placed in the mail reception awaiting condition and the presence or absence of mail reception is checked in step 701 at intervals of a predetermined time under the control of mail processor 170. When the absence of mail reception is determined in the step 701, the program returns to the mail reception awaiting condition and the mail processor 170 again waits for a lapse of the predetermined time When the presence of reception of a mail is determined in the step 701, the mail analyzer 172 in mail processor 170 analyzes the contents of the received mail and with the received mail described with certification information 1, the certification information 1 (305G1 in FIG. 14) described in the mail is acquired in step 702. Further, the CPU or MPU 101 compares, in step 703, the first certification information stored in the first certification information storing area 113 with the certification information 1 acquired from the received mail When in the step 703 the first certification information stored in the first certification information storing area 113 does not coincide with the certification information acquired from the received mail (inclusive of failure to acquire certification information 1 in the step 702), the program returns to the mail reception awaiting condition and the mail processor 170 again waits for a lapse of the predetermined time. When in the step 703 the first certification information stored in the first certification information storing area 113 coincides with the certification information 1 acquired from the received mail, the mail analyzer 172 in mail processor 170 analyzes the contents of the received mail and acquires, in step 704, certification information (305G2 in FIG. 14) described in the received mail. If, in this phase, the certification information 2 cannot be acquired or the acquired certification information 2 is invalid, the portable information terminal 100 returns to wait for reception of a mail in step 705. When the acquired certification information 2 is valid, the terminal lock controller 181 changes, in step 706, the information stored in the first certification information storing area 113 from the first certification information to the certification information 2 acquired from the received mail Though this process, the functional lock of the portable information terminal 100 is made unable to be unlocked by the first certification information but can be unlocked by only the certification information 2 acquired from the received mail, The received mail has a text display 305 of mail in which certification information 1 (305G1) and certification information 2 (305G2) are described as exemplified in FIG. 14.

Further, analyzing the contents of the received mail and acquiring certification information 1 and certification information 2 in the steps 702 and 704 may be dealt with only when the received mail has a prescribed format, for example, a statement “control instruction” (304G) in a title display 304 of mail as exemplified in FIG. 14 By doing so, useless analysis of the contents of an ordinary mail which is not described with certification information 1 and certification information 2 so as not to intend the functional lock of portable information terminal 100 can be omitted. In the case as above, when the title display 304 of mail lacks the statement “control instruction”, the program returns, needless to say, to the mail reception awaiting condition.

As described above, according to the portable information terminal 100 in the present embodiment, when losing the portable information terminal 100, the possessor can control the functional lock of the portable information terminal 100 through remote operation based on mail by using the first certification information set in advance. Also, the possessor of the portable information terminal 100 can change the certification information used for the functional lock of the portable information terminal from simple one (in the present embodiment, a PIN of a numerical string of about 4 digits) to sophisticated information the possessor designates, thus permitting the security to be improved in the event of lost of the portable information terminal 100. Furthermore, the possessor can anytime unlock the functional lock of portable information terminal 100 by using certification information the possessor designates. In addition, the possessor can change the certification information used for unlocking the functional lock of portable information terminal 100 by using any mail transmission device having mail addresses.

### Embodiment 8

The eighth embodiment of the present invention will now be described. It will be appreciated that the construction and advantageous effects in the present embodiment are also identical to those in embodiment 1 unless they are described to the contrary. Therefore, in the following description, differences between the present embodiment and embodiment 1 will be described principally.

Illustrated in FIG. 15 is a flowchart showing a certification information changing process in the present embodiment.

To add, in the present embodiment, the access information storing area 112 in storage 110 and the certification information generator 182 which are illustrated in the block diagram in FIG. 1 need not always be provided.

In using the portable information terminal 100 according to the present embodiment, the possessor registers in advance one or a plurality of management mail addresses used for admitting remote operation of controlling the functional lock of portable information terminal 100. Further, first certification information representing simplified information (for example, a PIN of a numerical string of 4 digits: 0123) is set in the first certification information storing area 113 and second certification information representing sophisticated information (for example, an alphanumeric string of about 18 digits: Oab1cd2ef3gh4ij5kl) is set in the second certification information storing area 114 and during ordinary operation, the portable information terminal 100 in the present embodiment has been applied with the functional lock by using the first certification information. Also, the functional lock of portable information terminal 100 can be unlocked by the first certification information.

When losing the portable information terminal 100 under the condition as above, the possessor of the portable information to terminal 100 can control the functional lock of the portable information terminal 100 through remote operation by using the registered management mail address. The portable information terminal 100 in the present embodiment operates as will be described below.

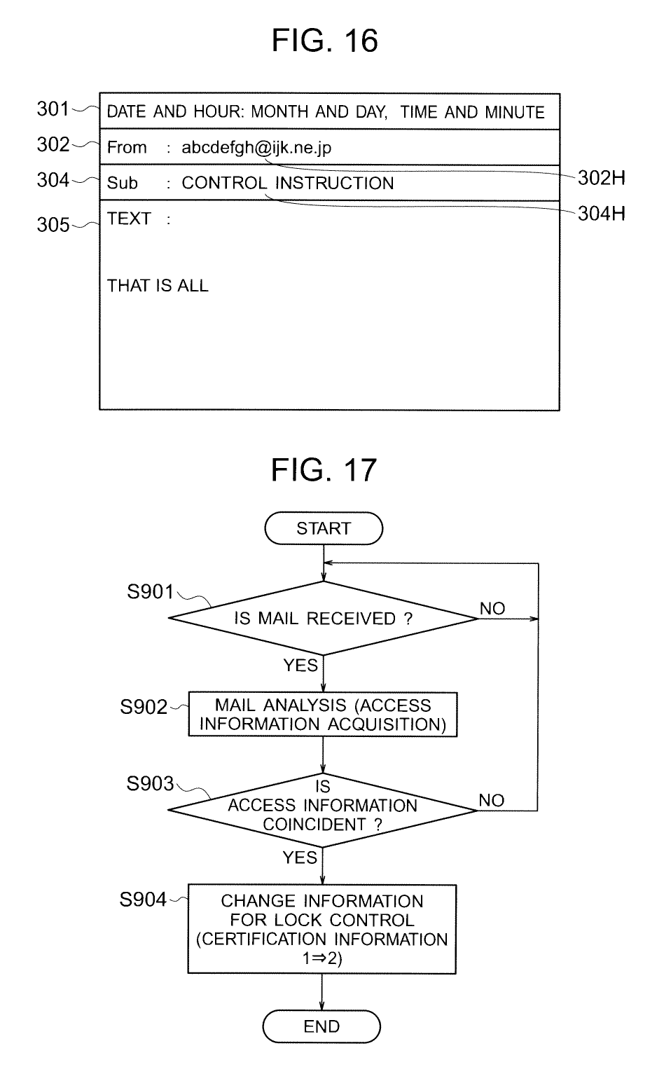

During normal operation, the portable information terminal 100 is placed in the mail reception awaiting condition and under the control of the mail processor 170, the presence or absence of mail reception is checked at intervals of a predetermined time in step 801 When the absence of mail reception is determined in the step 801, the program returns to the mail reception awaiting condition and the mail processor 170 again waits for a lapse of the predetermined time When the presence of reception of a mail is determined in the step 801 the CPU or MPU 101 compares, in step 802, the management address stored in the management address storing area ill with a mail address of the originator of transmission (302H in FIG. 16) of the received mail. When in the step 802 the management mail address stored in the management address storing area 111 does not coincide with the mail address of the originator of transmission of the received mail, the program returns to the mail reception awaiting condition and the mail processor 170 again waits for a lapse of the predetermined time When in the step 802 the management mail address stored in the management address storing area 111 coincides with the mail address of the originator of transmission of the received mail, the terminal lock controller 181 changes, in step 803, the information used for functional lock of portable information terminal 100 from the first certification information stored in the first certification information storing area 113 to the second certification information stored in the second certification information storing area 114. Through this process, the functional lock of portable information terminal 100 is made unable to be unlocked by the first certification information but can be unlocked by only the second certification information. In the received mail, any information may not be described in a text display 305 of mail as exemplified in FIG. 16

When the received mail has a prescribed format, the process for changing the information used for functional lock of portable information terminal 100 from the first certification information stored in the first certification information storing area 113 to the second certification information stored in the second certification information storing area 114 may be executed only when a statement “control instruction” (304 H) is described in the title display 304 of mail. By doing so, an ordinary mail not intending to execute the functional lock of portable information terminal 100 can be transmitted to the portable information terminal 100 from the management mail address stored in the management address storing area 111 In the case as above, when the title display 304 of mail lacks the statement “control instruction”, the program returns, needless to say, to the mail reception awaiting condition.

It is to be noted that pieces of certification information having different intensities are applied to the first certification information and the second certification information. For example, the digits of character string of the first certification information may differ from that of the second certification information or while constituting the first certification information by a character string of a numerical string only the second certification information may be constituted by an alphanumeric string including numerals and alphabetical characters. In an alternative, the certification information can be constituted by incorporating capital and small alphabetical letters in combination and symbols additionally, a plurality of pieces of certification information having different intensities can be set.

As described above, according to the portable information terminal 100 in the present embodiment, when losing the portable information terminal 100, the possessor can control through remote operation based on mail the functional lock of the portable information terminal 100 by using the management mail address registered in advance. Also, the possessor of the portable information terminal 100 can change the certification information used for the functional lock of the portable information terminal 100 (and for its unlocking) from simple one set for ordinary use application in the first certification information storing area 113 (in the present embodiment, a PIN of a numerical string of about 4 digits) to sophisticated information for security intensification stored in the second certification information storing area 114 (in the present embodiment, an alphanumeric string of about 18 digits), so that the security in the event of loss of the portable information terminal 100 can be improved. Further, since the certification information used for the functional lock of portable information terminal 100 need not be described in a mail, time and tabor consumed in the functional lock of the lost portable information terminal 100 can be suppressed considerably. In addition, the possessor can anytime unlock the functional lock of portable information terminal by using the certification information the possessor has set.

It will be appreciated that in order to specify which one of the first certification information and the second certification information can be used for unlocking the functional lock of portable information terminal 100, the storage 110, for example, may store a flag adapted for specifying certification information capable of unlocking the functional lock of portable information terminal 100 at that time. Alternatively, the storage 110 may further include a storage area for storing certification information per se by which the functional lock of portable information terminal 100 can be unlocked at that time.

### Embodiment 9

The ninth embodiment of the present invention will now be described. It will be appreciated that the construction and advantageous effects in the present embodiment are also identical to those in embodiment 1 unless they are described to the contrary. Therefore, in the following description, differences between the present embodiment and embodiment 1 will be described principally.

Illustrated in FIG. 17 is a flowchart showing a certification information changing process in the present embodiment.

To add, in the present embodiment, the management address storing area 111 in storage 110 and the certification information generator 182 which are illustrated in the block diagram in FIG. 1 need not always be provided.

In using the portable information terminal 100 according to the present embodiment, the possessor registers in advance access information used for admitting remote operation of controlling the functional lock of portable information terminal 100. Further, first certification information representing simplified one (for example, a PIN of a numerical g of about 4 digits, 0123) is set in the first certification information storing area 113 and second certification information representing sophisticated information (for example, an alphanumeric string of about 18 digits: Oab1cd2ef3gh4q5kl) is set in the second certification information storing area 114 and during ordinary operation, the portable information terminal 100 in the present embodiment has been applied with the functional lock by using the first certification information. Also, the functional lock of portable information terminal 100 can be unlocked by the first certification information.

When losing the portable information terminal 100 under the condition as above, the possessor of the portable information terminal 100 can execute control the functional lock of the portable information terminal 100 through remote operation by using the registered access information, The portable information terminal 100 in the present embodiment operates as will be described below.

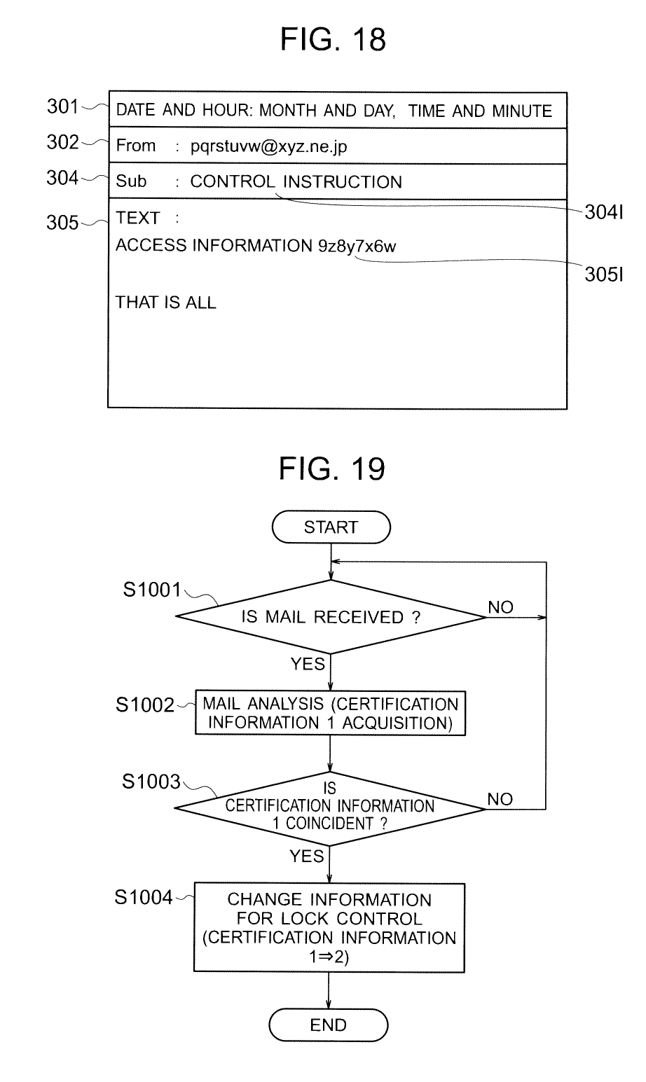

During normal operation, the portable information terminal 100 is placed in the mail reception awaiting condition and the presence or absence of mail reception is checked at intervals of a predetermined time under the control of mail processor 170 in step 901. When the absence of mail reception is determined in the step 901, the program returns to the mail reception awaiting condition and the mail processor 170 again waits for a lapse of the predetermined time. When the presence of reception of a mail is determined in the step 901, the mail analyzer 172 in mail processor 170 analyzes the contents of the received mail and with the received mail described with access information, the access information (3051 in FIG. 18) is acquired in step 902. Further, the CPU or MPU 101 compares, in step 903, the access information stored in the access information storing area 112 with the access information acquired from the received mail. When in the step 903 the access information stored in the access information storing area 112 does not coincide with the access information acquired from the received mail (inclusive of failure to acquire access information in the step 902), the program returns to the mail reception awaiting condition and the mail processor 170 again waits for a lapse of the predetermined time. When in the step 903 the access information stored in the access information storing area 112 coincides with the access information acquired from the received mail, the terminal lock controller 181 changes, in step 904, the information used for functional lock of the portable information terminal 100 from the first certification information stored in the first certification information storing area 113 to the second certification information stored in the second certification information storing area 114 Through this process, the functional lock of the portable information terminal 100 is made unable to be unlocked by the first certification information but can be unlocked by only the second certification information. The received mail has a text display 305 of mail in which access information (3051) is described as exemplified in FIG. 18

Further, analyzing the contents of the received mail and acquiring access information in the steps 902 may be dealt with only when the received mail has the prescribed format, for example, a statement “control instruction” (3041) in the title display 304 of mail as exemplified in FIG. 18. By doing so, useless analysis of the contents of an ordinary mail which is not described with access information so as not to intend the functional lock of portable information terminal 100 can be omitted. In the case as above, when the title display 304 of mail lacks the statement “control instruction”, the program returns, needless to say, to the mail reception awaiting condition.

As described above, according to the portable information terminal 100 in the present embodiment, when losing the portable information terminal 100, the possessor can control the functional lock of the portable information terminal 100 through remote operation based on mail by using the access information registered in advance. Also, the possessor of the portable information terminal 100 can change the certification information for the functional lock of the portable information terminal from simple one (in the present embodiment, a PIN of numerical string of about 4 digits) set in the first certification information storing area 113 for ordinary use to sophisticated information (in the present embodiment, an alphanumeric string of about 18 digits) set in the second certification information storing area 114 for promotion of security thus permitting the security to be improved in the event of lost of the portable information terminal 100 Furthermore, the possessor can anytime unlock the functional lock of portable information terminal by using certification information the possessor designates. In addition, the possessor can change the certification information used for unlocking the functional lock of portable information terminal 100 by using any mail transmission device having mail addresses.

### Embodiment 10

The tenth embodiment of the present invention will now be described, It will be appreciated that the construction and advantageous effects in the present embodiment are also identical to those in embodiment 1 unless they are described to the contrary. Therefore, in the following description, differences between the present embodiment and embodiment 1 will be described principally.

Illustrated in FIG. 19 is a flowchart showing a certification information changing process in the present embodiment.

To add, in the present embodiment, the management address storing area 111 and access information storing area 112 in storage 110 and the certification information generator 182 which are illustrated in the block diagram in FIG. 1 need not always be provided.

In using the portable information terminal 100 according to the present embodiment, first certification information representing simplified information (for example, a PIN of a numerical string of about 4 digits: 0123) is set in advance in the first certification information storing area 113 and second certification information representing sophisticated information (for example, an alphanumeric string of about 18 digits: Oab1cd2ef3gh4ij5kl) is set in advance in the second certification information storing area 114 Then, during ordinary operation, the portable information terminal 100 in the present embodiment has been applied with the functional lock by using the first certification information. Also, the functional lock of portable information terminal 100 can be unlocked by the first certification information.

When losing portable information terminal 100 under the condition as above, the possessor of the portable information terminal 100 can control the functional lock of the portable information terminal 100 through remote operation by using the first certification information, The portable information terminal 100 in the present embodiment operates as will be described below.

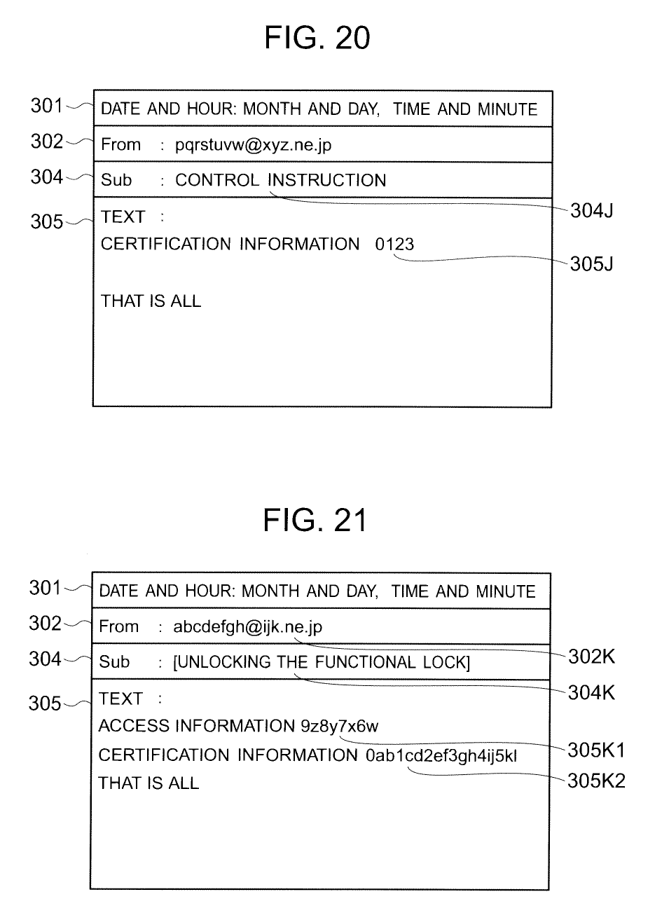

During normal operation, the portable information terminal 100 is placed in the mail reception awaiting condition and, under the control of the mail processor 170, the presence or absence of mail reception is checked at intervals of a predetermined time in step 1001. When the absence of mail reception is determined in the step 1001, the program returns to the mail reception awaiting condition and the mail processor 170 again waits for a lapse of the predetermined time When the presence of reception of a mail is determined in the step 1001, the mail analyzer 172 in mail processor 170 analyzes the contents of the received mail and with the received mail described with certification information, the certification information (305j in FIG. 20) described in the mail is acquired in step 1002 Further, the CPU or MPU 101 compares, in step 1003. the first certification information stored in the first certification information storing area 113 with the certification information acquired from the received mail. When in the step 1003 the first certification information stored in the first certification information storing area 113 does not coincide with the certification information acquired from the received mail (inclusive of failure to acquire the certification information in the step 1002), the program returns to the mail reception awaiting condition and the mail processor 170 again waits for a lapse of the predetermined time. When in the step 1003 the first certification information stored in the first certification information storing area 113 coincides with the certification information acquired from the received mail, the terminal lock controller 181 changes, in step 1004, the information used for functional lock of the portable information terminal 100 from the first certification information stored in the first certification information storing area 113 to the second certification information stored in the second certification information storing area 114. Through this process, the functional lock of portable information terminal 100 is made unable to be unlocked by the first certification information but can be unlocked by only the second certification information. To add, the received mail has a text display 305 of mail in which the certification information (305j) as exemplified in FIG. 20 is described.

Further, analyzing the contents of the received mail and acquiring access information in the step 1002 may be dealt with only when the received mail has a prescribed format, for example, a statement “control instruction” (304J) in a title display of mail as exemplified in FIG. 20. By doing so, useless analysis of the contents of an ordinary mail which is not described with certification information so as not to intend the functional lock of portable information terminal 100 can be omitted. In the case as above, when the title display 304 of mail lacks the statement “control instruction”, the program returns, needless to say, to the mail reception awaiting condition.

As described above, according to the portable information terminal 100 in the present embodiment, when losing the portable information terminal 100, the possessor can control the functional lock of the portable information terminal 100 through remote operation based on mail by using the first certification information registered in advance. Also, the possessor of the portable information terminal 100 can change the certification information used for the functional lock (and its unlocking) of the portable information terminal from simple one (in the present embodiment, a PIN of a numerical string of about 4 digits) set for ordinary use in the first certification information storing area 113 to sophisticated information (in the present embodiment, an alphanumeric string of about 18 digits) set for security promotion in the second certification information storing area 114, thus permitting the security to be improved in the event of loss of the portable information terminal 100. Furthermore, the possessor can anytime unlock the functional lock of portable information terminal by using certification information the possessor designates. Further, the possessor can change the certification information used for unlocking the functional lock of portable information terminal 100 by using any transmission device having mail addresses.

It is to be noted that when the portable information terminal 100 according to the individual embodiments is a pocket telephone, for example® and is used by connecting a SIM (Subscriber Identity Module) card or the like, the functional lock in each embodiment is desired to limit the function and operation of the portable information terminal 100 per se irrespective of the presence or absence of connection of the SIM card, and when the connection of SIM card is released with the functional lock rendered kept, the functional lock is desired not to be unlocked.

In carrying out the processes in steps 505, 606, 706, 803, 904 and 1004 in the previously described embodiments 5 to 10, not the all functions locked by the first certification information but predetermined part of the functions may be so changed as to be brought into the functional lock by the second certification information.

Further, even when the first certification information storing area 113 and the first certification information may be exchanged with the second certification information storing area 114 and the second certification information, respectively, features and advantageous effects of the present invention will by no means be impaired.

Furthermore, in performing the functional lock of the portable information terminal 100, information including personal data stored in the storage 110 may be encrypted by the certification information used for functional lock. In this case, concurrently with carrying out the processes in the steps 505, 606 and 706 in the embodiments 5 to 7, a process may be executed in which the information encrypted by the first certification information is once decrypted and the information is newly encrypted by the second certification information. Similarly, concurrently with carrying out the processes in the steps 803, 904 and 1004 in the embodiments 8 to 10, a process may be executed in which the information encrypted by the first information is once decrypted and the information is newly encrypted by the second certification information.

For unlocking the functional lock in the foregoing embodiments, the information used for the functional lock of portable information terminal 100 (for example, in the first embodiment, the certification information acquired from the received mail) may be inputted directly from the manipulation unit 150. Or, another method can be conceived in which the above information is described in a mail and transmitted to the portable information terminal 100 so that the functional lock may be unlocked through remote operation. In this case, if a management mail address used for permitting remote operation of controlling the functional lock of portable information terminal 100 is set in advance in the management address storing area 111, a mail having a statement of for example, “lock unlocking” (304K in FIG. 21) described in the title display 304 of mail and certification information (305k2 in FIG. 21) used for the functional lock described in the statement display 305 of mail may be transmitted from a mail transmission device having the management mail address so as to be destined for the portable information terminal 100. Or, if access information for admitting remote operation of controlling the functional lock of the portable information terminal 100 is set in advance in the access information storing area 112, a mail having a statement “unlocking the functional lock” (304K in FIG. 21) described in the title display 304 of mail and haying access information (305K1 in FIG. 21) and certification information (305K2 in FIG. 21) used for the functional lock which are described in the text display 305 of mail may be transmitted to the portable information terminal 100.

The mail address, access information and numerical/character string of certification information which are used or illustrated in connection with the description of the foregoing embodiments are examples at most and they can be different from those given so far without problem.

The present invention has been described by way of embodiments 1 to 10 but obviously, the construction for materializing the invention is in no way limited to that in each of the previously described embodiments. For example, part of construction of one embodiment can be replaced with the construction of another embodiment or part of construction of each of the embodiments can be deleted or added or replaced by or with construction of another embodiment. The aforementioned change or alternation is wholly within the framework of the present invention.

In addition, part or whole of the individual constructions, functions, processors and processing means may be materialized with hardware which is designed in the form of, for example, integrated circuits. The individual constructions and functions may be materialized with software by causing a processor to interpret a program for materializing individual functions and execute the program. More specifically, for example, packaged whole or part of a program and table and the like adapted to cause a computer to execute the aforementioned lock process and certification information changing process may be offered to the user of the portable information terminal through the medium of electrical communication lines or the like. Information such as represented by program, table, file or the like for materializing the individual functions may be stored in a recording unit such as a memory, hard-disk or SSD (Solid State Drive) or in a recording medium such as an IC card, SD card or the like,

In the foregoing, control lines and information lines are described which are considered to be necessary for explaining the invention but all control lines and information lines necessary for a product are not necessarily described. Actually, almost of constituents may be so considered as to be connected mutually.

1. A portable information terminal comprising:
mail address storing means for storing mail addresses;
mail reception means for receiving mails;
certification information generation means for generating certification information; and
terminal lock controlling means for limiting a predetermined function or operation,
wherein when an address stored in said mail address storing means coincides with a mail address of an originator of transmission of a mail received by said mail reception means, the predetermined function or operation is limited by certification information said certification information generating means generates.

2. A portable information terminal according to claim 1 further comprising mail transmission means for transmitting mails, wherein when said predetermined function or operation is limited by the certification information generated by said certification information generating means, said mail transmission means transmits a mail inclusive of said certification information to a mail address stored in said mail address storing means.

3. A portable information terminal comprising:
access information storing means for storing access information;
mail reception means for receiving mails,
certification information generation means for generating certification information; and
terminal lock controlling means for limiting a predetermined function or operation;
wherein when a mail received by said mail reception means includes said access information stored in said access information storing means, said terminal lock controlling means limits the predetermined function or operation by using the certification information said certification information generating means generates.

4. A portable information terminal according to claim 3 further comprising mail transmission means for transmitting mails, wherein when said predetermined function or operation is limited by certification information said certification information generation means generates, said mail transmission means transmits a mail including said certification information to a mail address of the originator of transmission of the mail including said access information.

5. A portable information terminal according to claim 3, wherein when the mail received by said mail reception means has a prescribed format, a decision is made as to whether the mail received by said mail reception means includes said access information stored in said access information storing means.

6. A method for controlling a portable information to final comprising the steps of
storing mail addresses;
receiving mails;
comparing a mail address stored in the step of storing mail addresses with a mail address of an originator of transmission of the mail received in the step of receiving mails.
generating certification information; and
limiting a predetermined function or operation by using the certification information generated in the step of generating certification information when the result of comparison of the mail addresses in the step of comparing mail addresses shows that the mail address stored in the step of storing mail addresses coincides with the mail address of the originator of transmission of the mail received in the step of receiving mails

7. A method for controlling a portable information terminal comprising the steps of:
storing access information;
receiving mails;
generating certification information; and
controlling lock of the terminal so as to limit predetermined function or operation by using certification information generated in the step of generating certification information when said access information stored in the step of storing the access information is included in a mail received in the step of receiving mails.

8. A program for causing a computer to execute the steps of:
storing mail addresses; receiving mails;
comparing a mail address stored in the step of storing mail addresses with a mail address of an originator of transmission of the mail received in the step of receiving mails;
generating certification information; and
controlling terminal lock for limiting a predetermined function or operation of the terminal by using the certification information generated in the step of generating certification information when the result of comparison of the mail addresses in the step of comparing mail addresses shows that the mail address stored in the step of storing mail addresses coincides with the mail address of the originator of transmission of the mail received in the step of receiving mails.

9. A program for causing a computer to execute the steps of:
storing access information;
receiving mails;
generating certification information; and
limiting a predetermined function or operation of the terminal by using the certification information generated in the step of generating certification information when said access information stored in the step of storing access information is included in a mail received in the step of receiving mails.

10. A portable information terminal according to claim 4, wherein when the mail received by said mail reception means has a prescribed format, a decision is made as to whether the mail received by said mail reception means includes said access information stored in said access information storing means.

11. A portable information terminal according to claim 1, wherein said predetermined function is the electronic money function used in money transaction.
